(19) United States
(12) Patent Application Publication
(10) Pub. No.: US 2009/0029219 A1
(43) Pub. Date: Jan. 29, 2009

(54) CATALYST, PROCESS FOR PRODUCING THE CATALYST, MEMBRANE ELECTRODE ASSEMBLY, AND FUEL CELL

(75) Inventors: Taishi FUKAZAWA, Fuchu-Shi (JP); Wu MEI, Yokohama-Shi (JP); Tsuyoshi KOBAYASHI, Kawasaki-Shi (JP); Itsuko MIZUTANI, Yokohama-Shi (JP); Masaaki YAMAMOTO, Inzai-Shi (JP); Yoshihiko NAKANO, Yokohama-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/121,282

(22) Filed: May 15, 2008

(30) Foreign Application Priority Data
Jul. 25, 2007 (JP) 2007-193317

(51) Int. Cl. H01M 8/10; B01J 21/06; B01J 23/02; B01J 23/42; B05D 5/12

(52) U.S. Cl. 429/30; 502/252; 502/306; 502/328; 502/183; 427/78

(57) ABSTRACT

This invention provides a highly active and stable catalyst, which is suitable for use in fuel cells while suppressing the amount of expensive noble metals used, i.e., platinum (Pt) and ruthenium (Ru), and a process for producing the catalyst, and a membrane electrode assembly and fuel cell using the catalyst. The catalyst comprises: an electro conductive support; and catalyst particles supported on the electro conductive support and having a composition represented by formula (1)

PtᵤRuₓMg_{y}T_{z} (1)

wherein u is 30 to 60 atm %, x is 20 to 50 atm %, y is 0.5 to 20 atm %, and z is 0.5 to 40 atm %,

element T being selected from the group consisting of silicon (Si), tungsten (W), molybdenum (Mo), vanadium (V), tantalum (Ta), chromium (Cr), titanium (Ti), hafnium (Hf), tin (Sn), zirconium (Zr), niobium (Nb), and combinations thereof, provided that

when element T is silicon, tungsten, molybdenum, vanadium, tantalum, or chromium, the content of element T having an oxygen bond is four times or less the content of element T having a metallic bond, and
when element T is titanium, hafnium, tin, zirconium, or niobium, the content of element T having a metallic bond is twice or less the content of element T having an oxygen bond.

### CROSS-REFERENCE TO RELATED APPLICATIONS

This application is based upon and claims the benefit of priority from the prior Japanese Patent Applications No. 193317/2007, filed on Jul. 25, 2007; the entire contents of which are incorporated herein by reference.

### BACKGROUND OF THE INVENTION

1. Field of the Invention

The present invention relates to a catalyst and a membrane electrode assembly suitable for use in fuel cell, a fuel cell and a method for producing the catalyst.

2. Background Art

Fuel cells have recently drawn attention as power generation means which can convert chemical energy directly into electric energy and environmentally friendly. Among others, direct methanol-type fuel cells (hereinafter often referred to as “DMFC”) have drawn particular attention because the conversion efficiency is high and is theoretically 97% and, in the case of a hydrogen fuel (hereinafter often referred to as “PEFC”), is theoretically as high as 83%. Further, DMFC does not need the provision of a reformer because of direct supply of a liquid fuel and is suitable for low-temperature operation, and, thus, there is increasing expectation for the use of DMFC as power supplies alternative to rechargeable batteries for portable equipment. In DMFC, a currently commonly used methanol oxidation catalyst is platinum (Pt). Platinum, however, is disadvantageous in that the catalytic activity is significantly deteriorated as a result of poisoning of the surface by carbon monoxide which is an intermediate product in the power generation.

The use of a PtRu alloy is considered effective as one of means for eliminating the poisoning. In this PtRu alloy, oxygen species adsorbed on the surface of ruthenium (Ru) is reacted with carbon monoxide adsorbed on the surface of platinum. Accordingly, it is considered that poisoning by carbon monoxide is less likely to occur and the deterioration in catalytic activity can be suppressed. Platinum and ruthenium, however, are disadvantageous in that, since platinum and ruthenium are expensive noble metals, the use of the PtRu alloy results in the consumption of a large amount of expensive noble metals and causes increased cost. Accordingly, the development of a catalyst, which has a higher activity despite its reduced content, is greatly expected, and research and development of such catalyst are forwarded.

One of such research and development aims at improved activity by the addition of other element(s) to the PtRu alloy. As an example, it is known that an alloy of platinum with base metals typified by tin and molybdenum is also effective in eliminating poisoning of carbon monoxide. This method, however, has a drawback that the metal added under acidic conditions is eluted. Further, U.S. Pat. No. 3,506,494 discloses the addition of ten metals such as tungsten, tantalum, and niobium. It should be noted that, even in an identical catalyst composition, the surface state of the catalyst varies greatly depending upon the synthesis process, and a change in catalyst surface state greatly affects the catalytic activity. In U.S. Pat. No. 3,506,494, there is no satisfactory description on the synthesis process which greatly affects the surface state of the catalyst, and, hence, this poses a problem that desired catalytic activity is not always provided. In fact, Japanese Patent Laid-Open No. 259557/2005 discloses a process for producing an anode catalyst by adding group 4 to 6 metals of the periodic table to platinum and ruthenium by an immersion method, and it is reported that the methanol activity varies greatly depending upon the order of immersion. Regarding the mixing ratio of platinum, ruthenium, and a group 4 to 6 metal, Japanese Patent Laid-Open No. 259557/2005 describes only that platinum: ruthenium: additive metal weight ratio=317.7: 82.3: 100.

Under such circumstances, what is expected is to control a catalyst synthesis process and to synthesize novel catalyst particles having a nano structure, thereby developing a catalyst having a higher activity than the PtRu alloy. In this connection, it should be noted that, regarding a solution method such as an immersion method which has hitherto been commonly used in catalyst synthesis, for elements which cannot be reduced without difficulties and elements which cannot be alloyed without difficulties, the structure and surface of catalysts cannot be disadvantageously controlled without difficulties.

On the other hand, catalyst synthesis by sputtering or vapor deposition is advantageous in material control. However, studies on items which affect the process, for example, element type, catalyst composition, substrate material, and substrate temperature are unsatisfactory. Since most of catalyst particles are nano particles, there is a tendency that the surface electron state of catalyst particles and the nano structure of catalyst particles greatly depend upon the type of element added to the particle and the addition amount. Optimization of element type, element addition amount, and a combination of elements added to the catalyst particles is expected to provide high active and highly stable catalyst particles. U.S. Pat. No. 6,171,721 discloses a four-way catalyst produced by sputtering. In this patent, a number of elements which can be added are cited and exemplified. However, there is no description on the composition of individual elements. U.S. Pat. No. 5,872,074 discloses a PtRuMg catalyst as an example of catalyst containing magnesium. In this publication, however, there is no description on four-way catalysts.

### SUMMARY OF THE INVENTION

Under such circumstances, the present invention has been made, and an object of the present invention is to provide a highly active and stable catalyst, which is suitable for use in fuel cells while suppressing the amount of expensive noble metals used, i.e., platinum and ruthenium, and a process for producing the catalyst, and a membrane electrode assembly and fuel cell using the catalyst.

The present inventors have made extensive and intensive studies on a catalyst synthesis process and a catalyst composition with a view to attaining the above object. As a result, it was found that the formation of catalyst particles represented by the following formula (1) or (2), preferably the adoption of sputtering or vapor deposition on an electro conductive support in incorporating element T in a PtRu alloy, can provide catalysts having high activity and high stability while reducing the amount of platinum and ruthenium added.

According to the present invention, there is provided a catalyst comprising:
an electro conductive support; and
catalyst particles supported on the electro conductive support and having a composition represented by formula (1)

PtᵤRuₓMg_{y}T_{z} (1)

wherein u is 30 to 60 atm %, x is 20 to 50 atm %, y is 0.5 to 20 atm %, and z is 0.5 to 40 atm %,

element T being selected from the group consisting of silicon (Si), tungsten (W), molybdenum (Mo), vanadium (V), tantalum (Ta), chromium (Cr), titanium (Ti), hafnium (Hf), tin (Sn), zirconium (Zr), niobium (Nb), and combinations thereof, provided that

when element T is selected from the group consisting of silicon, tungsten, molybdenum, vanadium, tantalum, chromium, and combinations thereof, the content of element T having an oxygen bond as determined by a spectrum measured by X-ray photoelectron spectroscopy is four times or less the content of element T having a metallic bond, and

when element T is selected from the group consisting of titanium, hafnium, tin, zirconium, niobium, and combinations thereof, the content of element T having a metallic bond as determined by a spectrum measured by X-ray photoelectron spectroscopy is twice or less the content of element T having an oxygen bond.

In a preferred embodiment of the present invention, in formula (1), y is 1 to 10 atm %.

According to another aspect of the present invention, there is provided a process for producing the above catalyst of the present invention, comprising the step of depositing platinum, ruthenium, magnesium, and element T on an electro conductive support held at 400° C. or below by sputtering or vapor deposition.

According to still another aspect of the present invention, there is provided a membrane electrode assembly comprising a cathode, an anode comprising the above catalyst of the present invention, and a proton-conductive film provided between the cathode and the anode.

According to a further aspect of the present invention, there is provided a fuel cell comprising the above membrane electrode assembly of the present invention.

### BRIEF DESCRIPTION OF THE DRAWING

FIG. 1 is a conceptual diagram showing the construction of one embodiment of a direct methanol-type fuel cell.

### DETAILED DESCRIPTION OF THE INVENTION

Embodiments of the present invention will be described.

<Catalyst>

The catalyst of the present invention comprises an electro conductive support and catalyst particles supported on the electro conductive support and having a composition represented by formula (1). Each of the electro conductive support and catalyst particles will be described.

<Catalyst Particles>

The catalyst for use in the present invention has a composition represented by formula (1) and is a four or higher way catalyst comprising platinum (Pt), ruthenium (Ru), and magnesium (Mg) as indispensable constitutents.

<Re: Platinum and Ruthenium>

Platinum is very effective for oxidation of hydrogen and a dehydrogenation reaction of an organic fuel, and ruthenium is very effective for CO poisoning suppression. For the above reason, u is limited to 30 to 60 atm %.

When the ruthenium content is excessively low, the catalytic activity is unsatisfactory. Accordingly, x is limited to 20 to 50 atm %.

The platinum element present in the catalyst according to the present invention is in a metallic bond state, and, in addition, in some cases, a platinum element having an oxygen bond is present. It is considered that an oxide layer formed of platinum (and ruthenium, magnesium, and element T) is present on the surface of the catalyst and, by virtue of the presence of the oxide layer, high activity and high stability are imparted. The content of the platinum element having an oxidative bond in the catalyst is so low that the oxide layer cannot be grasped by XPS. In an X-ray absorption microstructure measurement method (XANES), the oxide layer can be analyzed by comparison of an XANES spectrum of the catalyst with an XANES spectrum of a platinum metal foil (a standard sample) and an XANES spectrum of a platinum oxide (a standard sample). Further, replacement of a part of PtRu with other metal, for example, noble metals such as rhodium (Rh), osmium (Os), and iridium (Ir), which are particularly excellent in chemical stability, can improve the activity.

<Re: Magnesium>

In the present invention, the addition of magnesium to the PtRu alloy can contribute to improved activity of the PtRu-base catalyst by virtue of the co-catalyst activity. The detailed mechanism of the improvement in activity is unknown but is believed that the improved activity is realized mainly by a change in surface structure and electron state of the catalyst attributable to a specific mixed state of magnesium. Further, when magnesium having a metallic bond is present, the activity is sometimes improved. The content of magnesium in the catalyst particles represented by formula (1) or (2) is preferably 0.5 to 20 atm %. When the magnesium content is less than 0.5 atm % or more than 20 atm %, any satisfactory co-catalyst activity of magnesium cannot be provided. The magnesium content is more preferably in the range of 1 to 10 atm %.

<Re: T>

In the present invention, the addition of element T to the PtRu alloy can contribute to a further improvement in catalytic activity over PtRuMg by virtue of co-catalyst activity. The content of element T is preferably 0.5 to 40 atm %. Not only when the content of element T is less than 0.5 atm % but also when the content of element T is more than 40 atm %, the co-catalyst activity of element T is not satisfactory.

When element T is selected from the group consisting of silicon, tungsten, molybdenum, vanadium, tantalum, chromium, and combinations thereof, the content of element T having an oxygen bond as determined by a spectrum measured by XPS is four times or less, more preferably twice or less, the content of the same element T but having a metallic bond. When the content of element T having an oxygen bond is above the upper limit of the above-defined content range, satisfactory co-catalyst effect of element T cannot be attained without difficulties.

When element T is selected from the group consisting of titanium, hafnium, tin, zirconium, niobium, and combinations thereof, the content of element T having a metallic bond as determined by a spectrum measured by XPS is twice or less, more preferably one time or less, the content of the same element T but having an oxygen bond. When the content of element T having a metallic bond is above the upper limit of the above-defined content range, satisfactory co-catalyst effect of element T cannot be attained without difficulties.

The XPS measurement is a measuring method which can realize detection to a depth of approximately several nanometers near the surface of the sample (a very large proportion of total signal intensity is accounted for by a part near the surface). Accordingly, the above description means that element T, which is bonded by oxygen bond to element T in a metallic state, is present in a predetermined proportion within several nanometers from the surface of the catalyst particles. An oxide layer is likely to be formed on the surface of the catalyst fine particles. Therefore, the peak area (signal) attributable to an oxidative bond of the element T in a spectrum measured by XPS measurement is likely to be a larger value than the peak area attributable to the metallic bond. The presence of a surface oxide layer containing element T (and other elements) having an oxygen bond is considered as contributing to improved catalytic performance. On the other hand, for the element T in a metallic state, metallic nanoparticles consisting of element T alone cannot be stably present in the air. Accordingly, in the supported catalyst according to the present invention, specifically, it is considered that particles of an alloy of element T with platinum and ruthenium are present. In fact, as a result of analysis of an XRD spectrum of the catalyst particles by XRD (analysis by X-ray diffractometry), regarding the main peak position, unlike the PtRu alloy (in which the face-to-face dimension of the PtRu alloy is about 2.23 angstroms at Pt/Ru=1:1 and about 2.21 angstroms at Pt/Ru=1:1.5 and the incorporation of an additive element(s) leads to a change in structure and thus a change in face-to-face dimension), the addition of magnesium and element T has caused a change in an alloy structure and has brought the face-to-face dimension of the crystal face of the main peak in the catalyst particles to 2.16 to 2.25 angstroms. The electronic interaction of the presence of a metallic bond between the element T and platinum, ruthenium and magnesium with other catalyst metals is considered important from the viewpoint of catalytic activity and sometimes contributes to an improvement in catalytic activity. However, the details of the mechanism have not been fully elucidated.

The presence of a metallic bond of the element T in the catalyst according to the present invention can also be confirmed by X-ray absorption microstructure measurement (EXAFS). In EXAFS, X rays pass through the whole catalyst. Accordingly, as with XRD (X-ray diffractometry), EXAFS can measure information on binding of the whole catalyst. According to radial structure distribution of each element T measured by EXAFS, a strong peak (bond distance: 2 to 3 angstroms) attributable to the metallic bond of the element T was observed.

<Re: Oxygen>

In the present invention, the catalyst may contain oxygen. In fact, even when the incorporation of oxygen is not intended, there is a possibility of oxidation of the surface of the catalyst by oxygen adsorption on the surface of the catalyst during the synthesis process or in the storage of the catalyst, or surface oxidation treatment such as acid pickling. When there is a minor level of oxidation on the surface of the catalyst, in some cases, catalytic activity and stability are improved. The oxygen content of the catalyst is preferably not more than 25 atm %. When the oxygen content exceeds 25 atm %, the catalytic activity is sometimes significantly deteriorated. The other description regarding the catalyst composition in the specification basically shows “charge composition” of sputters.

<Form of Catalyst Particles>

In the present invention, the catalyst particles is preferably in the form of nano-size fine particles because a higher level of activity can be provided. Specifically, the average particle diameter of the catalyst particles is preferably not more than 10 nm. This is because, when the average particle diameter exceeds 10 nm, there is possibility that the activity efficiency of the catalyst is deteriorated. The average particle diameter of the catalyst particles is more preferably in the range of 0.5 to 10 nm. When the average particle diameter of the catalyst particles is less than 0.5 nm, the control of the catalyst synthesis process is difficult, and the cost of the catalyst synthesis is increased. Regarding the catalyst particles, fine particles having an average particle diameter of not more than 10 nm as such may be used. Alternatively, aggregates of primary particles formed of the fine particles (secondary particles) may be used.

<Electro conductive Support>

Any electro conductive support may be used in the present invention so far as the electroconductivity and stability are excellent. An example of this material is carbon black. Nanocarbon materials, for example, fiber-, tube-, and coil-shaped materials may also be used. These nanocarbon materials are different from each other in surface state. Accordingly, when the catalyst particles according to the present invention are supported on these nanocarbon materials, the activity of the catalyst particles can be further improved. In addition to carbon materials, for example, electro conductive ceramic materials may be used as a support. In this case, further, the synergistic effect of the ceramic support and the catalyst particles can be developed.

<Production Process>

Next, the production process of the catalyst according to the present invention will be described. The catalyst according to the present invention is produced, for example, by sputtering or vapor deposition. These methods are advantageous in that, as compared with solution methods such as an impregnation method, a precipitation method, a colloid method, an electrodeposition method, and an electrophoresis method, catalysts having a specific mixed state (alloyed) having a metallic bond can be more easily produced.

When the catalyst particles are deposited onto an electro conductive support by sputtering, an alloy target may be used, or alternatively a method may be adopted in which two or more targets are simultaneously sputtered. A typical method is as follows. At the outset, a particulate or fibrous electro conductive support is satisfactorily dispersed. Next, the dispersed support is placed in a holder provided in a chamber in a sputtering apparatus, and, with stirring of the electro conductive support, catalyst constituent metals are deposited onto the support by sputtering. The temperature of the support during sputtering is preferably brought to 400° C. or below. When the temperature is above 400° C., phase separation occurs in the catalyst particles and, consequently, the catalytic activity sometimes becomes unstable. Further, in order to reduce the cost necessary for cooling of the support, the lower limit of the support temperature is preferably brought to 10° C. The support temperature can be measured with a thermocouple.

Stirring is preferably carried out from the viewpoint of realizing homogeneous catalyst deposition. When stirring is not carried out, uneven distribution of the catalyst occurs and, consequently, there is a possibility that fuel cell characteristics are deteriorated.

The catalyst of the present invention may be sputtered directly on an electro conductive carbon fiber-containing porous paper, electrode diffusion layer, or electrolyte membrane. In this case, preferably, the catalyst is formed in a nanoparticle state by regulating the process. Further, in the same manner as described above, the temperature of the porous paper is preferably brought to 400° C. or below.

After the formation of the catalyst particles by sputtering or vapor deposition, preferably, acid pickling treatment or heat treatment can be carried out to further improve the activity. This is probably because the catalyst structure or surface structure is further rendered proper by the acid pickling treatment or heat treatment. In the acid pickling treatment, any aqueous acid solution may be used. In the present embodiment, an aqueous sulfuric acid solution was used. Post heat treatment is preferably carried out at 10 to 400° C. in an atmosphere having an oxygen partial pressure of less than 5%. In order to facilitate the formation of fine particles, other material such as carbon and constituent metal elements may be simultaneously sputtered or vapor deposited. In the present invention, metals having good dissolubility, for example, copper and zinc, and constituent metal elements can be simultaneously sputtered or vapor deposited followed by acid pickling or the like to remove the copper, zinc and the like.

<Fuel Cell and Membrane Electrode Assembly>

One embodiment of the structure of the fuel cell according to the present invention will be described.

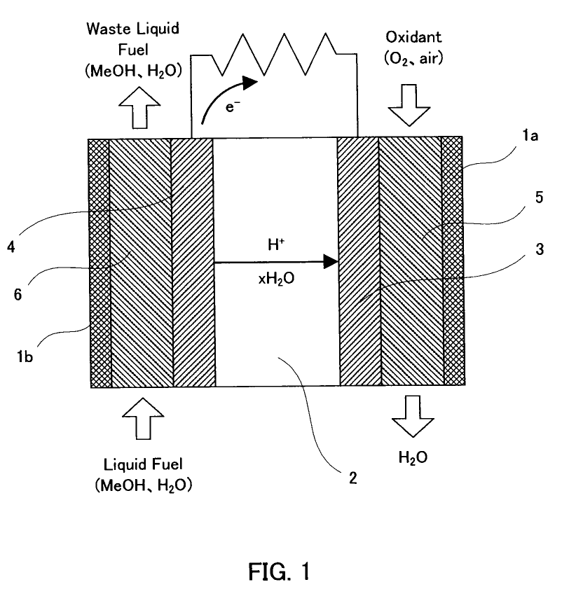

FIG. 1 is a conceptual diagram showing a single cell in a fuel cell. In FIG. 1, an electrolyte membrane 2, and an oxidizing agent electrode (a cathode) 3 and a fuel electrode (an anode) 4 holding the electrolyte membrane 2 therebeween are provided within casings 1a, 1b. An oxidizing agent flow passage 5 and a liquid fuel flow passage 6 are provided on the outer side of the oxidizing agent electrode 3 and the outer side of the fuel electrode 4, respectively.

An ion exchange membrane is used as the electrolyte membrane 2. The ion exchange membrane may be any of anion and cation conduction types. However, the proton conduction type is mainly used. For example, anion or cation conductive materials such as polymeric membranes typified by perfluoroalkylsulfonic acid polymers may be used. The electrolyte membrane 2 is interposed and held between the oxidizing agent electrode 3 and the fuel electrode 4 to form a membrane electrode assembly. Alternatively, the oxidizing agent electrode 3, the electrolyte membrane 2, and the fuel electrode 4 are bonded to one another, for example, by hot pressing or cast film formation. If necessary, a water repellant typified by polytetrafluoroethylene may be added or stacked on a porous carbon paper or a carbon cloth (corresponding to numerals 3 and 4 in the drawing).

The fuel electrode 4 is an electrode comprising the above methanol oxidation catalyst as an active component. The fuel electrode 4 is abutted against the electrolyte membrane 2. The fuel electrode 4 may be abutted against the electrolyte membrane 2 by conventional methods including hot pressing or cast film formation.

In many cases, the oxidizing agent electrode 3 as well is formed by mixing a platinum-supported carbon with an ion conductive material thoroughly and abutting the mixture against the electrolyte membrane 2. When the ion conductive material is the same as the material constituting the electrolyte membrane 2, favorable results can be obtained. The oxidizing agent electrode 3 may be abutted against the ion exchange membrane 2 by conventional methods including hot pressing or cast film formation. In addition to platinum-supported carbon, the oxidizing agent electrode 3 may be a conventional one such as a noble metal or its supported material (an electrode catalyst), an organometal complex, or an organometal complex baked product. Alternatively, these materials may be used in a nonsupported state without supporting on the support.

On the oxidizing agent electrode 3 side, an oxidizing agent introduction hole (not shown) for introducing an oxidizing agent (in many cases, air) into the upstream side is provided. On the other hand, on the downstream side, an oxidizing agent discharge hole (not shown) for discharging unreacted air and the product (in many cases, water) is provided. In this case, forced exhaustion and/or forced exhaustion means may be provided. Further, a natural convection hole for air may be provided in the casing 1a.

On the outer side of the fuel electrode 4, a liquid fuel flow passage 6 is provided. The liquid fuel flow passage 6 may be a flow passage in communication with an external fuel storage part (not shown), or alternatively may be a site for storing a methanol fuel. On the downstream side, a discharge hole (not shown) for discharging a methanol fuel remaining unreacted and a product (in many cases, CO₂) is provided. In this case, forced exhaustion and/or forced exhaustion means may be provided.

Methanol alone or a mixture of methanol with water is suitable as the fuel supplied directly into the fuel electrode 4. When a mixture of with methanol is used, crossover can be effectively prevented and, thus, better cell electromotive force and power output can be realized.

The direct methanol-type fuel cell shown in FIG. 1 (a conceptual diagram) shows only a single cell. In the present invention, however, this single cell as such may be used. Alternatively, a plurality of cells may be connected in series and/or parallel to constitute a mounted fuel cell. Cells may be connected by a conventional connection method using a bipolar plate, or a planar connecting method. The adoption of other conventional connecting methods is, of course, also useful.

Fuels usable herein include methanol and, further, ethanol, formic acid, or an aqueous solution containing at least one of them.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

### EXAMPLES

Embodiments of the present invention will be further described by the following Examples which are specific but not limitative of the present invention.

<Production of Catalysts>

### Examples 1 to 8 and 11 to 20, and Comparative Examples 1 to 4 and 7 to 9)

A carbon black support (tradename: Vulcan XC72; specific surface area: about 230 m²/g; manufactured by Cabot Corporation) was first satisfactorily dispersed. Next, the dispersed support was placed in a holder provided in a chamber within an ion beam sputtering apparatus. When the degree of vacuum reached not more than 3×10⁻⁶ Torr, argon (Ar) gas was allowed to flow thereinto. Sputtering was carried out using metals or alloys provided as a target according to the above procedure so as to provide various compositions shown in Table 1 to adhere catalyst fine particles onto the support. The assemblies were subjected to acid pickling with an aqueous sulfuric acid solution (100 g of sulfuric acid and 200 g of water), were then washed with water, and were dried.

### Examples 9 and 10

A carbon black support (tradename Vulcan XC72 ; specific surface area: about 230 m²/g; manufactured by Cabot Corporation) was first satisfactorily dispersed. The dispersed support was then placed in a holder provided in a chamber within a laser pulse vapor deposition apparatus. When the degree of vacuum reached not more than 3×10⁻⁶ Torr. Vapor deposition was carried out using metals or alloys provided according to the above procedure so as to provide various compositions shown in Table 1 to adhere catalyst particles onto the support. The assemblies were subjected to acid pickling with an aqueous sulfuric acid solution (100 g of sulfuric acid and 200 g of water), were then washed with water, and were dried.

### Comparative Example 5

Carbon black (tradename Vulcan XC72 ; specific surface area: about 230 m²/g; manufactured by Cabot Corporation) (800 mg) was added to 1000 mL of an ethanol solution containing magnesium chloride (90 mg in terms of magnesium metal) and tungsten chloride (681 mg in terms of tungsten metal), and the mixture was satisfactorily stirred for homogeneous dispersion. The homogeneous dispersion liquid thus obtained was then heated under stirring at 55° C. to evaporate and remove ethanol. The resultant residue was heated at 30° C. for 3 hr while allowing hydrogen gas to flow into the system at a flow rate of 50 mL/min to support magnesium and tungsten on carbon black. Next, 800 mL of a cyclohexane solution containing 1,5-cyclooctadiene dimethyl platinum (2890 mg in terms of platinum metal) was mixed with 200 mL of an ethanol solution containing ruthenium chloride (1498 mg in terms of ruthenium metal). The above magnesium and tungsten-supported carbon were added to the mixed solution, and the mixture was satisfactorily stirred for homogeneous dispersion. The homogeneous dispersion liquid thus obtained was heated under stirring at 55° C. to evaporate and remove the solvent. The resultant residue was heated at 300° C. for 3 hr while allowing hydrogen gas to flow into the system at a flow rate of 50 mL/min to support platinum, ruthenium, magnesium, and tungsten on carbon black to provide a supported catalyst.

### Comparative Example 6

A catalyst of Pt₁₀Ru₁₀Mg₈₀ was synthesized in the same manner as in Example 1 of U.S. Pat. No. 5,872,074.

TABLE 1

| | | T1 | T2 | | | |
|---|---|---|---|---|---|---|
| | | peak | peak | Catalyst | | 1000- |
| | Catalyst | area | area | production | | hr |
| | composition | ratio | ratio | process | Voltage, V | deterioration, % |
| Ex. 1 | Pt₄₀Ru₄₀W₁₀Mg₁₀ | 0.8 | — | Sputtering | 0.49 | 0.5% |
| Ex. 2 | Pt₄₀Ru₃₅W₁₀Mg₁₅ | 0.8 | — | Sputtering | 0.48 | 0.5% |
| Ex. 3 | Pt₃₅Ru₃₅W₁₀Mg₂₀ | 0.7 | — | Sputtering | 0.48 | 0.5% |
| Ex. 4 | Pt₃₀Ru₂₀W₄₀Mg₁₀ | 1.9 | — | Sputtering | 0.47 | 0.5% |
| Ex. 5 | Pt₃₅Ru₂₉Hf₁₅Nb₇V₆Mg₈ | — | 0.2 | Sputtering | 0.52 | 0.5% |
| Ex. 6 | Pt₄₀Ru₃₅Zr₁₅Mg₁₀ | — | 0.5 | Sputtering | 0.50 | 0.5% |
| Ex. 7 | Pt₄₀Ru₃₂Cr₁₄Ti₁₃Mg₁ | 2.3 | — | Sputtering | 0.49 | 0.5% |
| Ex. 8 | Pt₄₀Ru₃₅Sn₁₅Mg₁₀ | — | 0.8 | Sputtering | 0.48 | 0.6% |
| Ex. 9 | Pt₃₅Ru₃₅V₂₅Mg₅ | 0.5 | | Vapor | 0.49 | 0.5% |
| | | | | deposition | | |
| Ex. | Pt₄₀Ru₃₀Zr₁₁V₉Ta₈Mg₂ | | 0.5 | Vapor | 0.48 | 0.5% |
| 10 | | | | deposition | | |
| Ex. | Pt₃₅Ru₃₀Ni₁₀W₁₅Mg₁₀ | 0.9 | | Sputtering | 0.48 | 0.5% |
| 11 | | | | | | |
| Ex. | Pt₄₀Ru₃₇Si₁₇Mg₆ | 3.5 | | Sputtering | 0.49 | 0.5% |
| 12 | | | | | | |
| Ex. | Pt₄₀Ru₃₂Zr₁₃Mo₁₀Mg₅ | | 0.7 | Sputtering | 0.50 | 0.5% |
| 13 | | | | | | |
| Ex. | Pt₄₀Ru₃₀Ta₈V₅Zr₇Ni₅Mg₅ | 2.8 | | Sputtering | 0.52 | 0.5% |
| 14 | | | | | | |
| Ex. | Pt₄₀Ru₃₂W₁₀Ni₁₃Mg₅ | 1.3 | | Sputtering | 0.49 | 0.5% |
| 15 | | | | | | |
| Ex. | Pt₃₅Ru₃₀Ni₁₀Zr₁₅Mg₁₀ | | 0.6 | Sputtering | 0.49 | 0.5% |
| 16 | | | | | | |
| Ex. | Pt₄₀Ru₃₂Ni₁₄Ti₁₃Mg₁ | | 1.7 | Sputtering | 0.48 | 0.5% |
| 17 | | | | | | |
| Ex. | Pt₄₀Ru₃₅Hf₁₀Mg₁₅ | | 0.2 | Sputtering | 0.49 | 0.5% |
| 18 | | | | | | |
| Ex. | Pt₄₀Ru_{30.5}Sn₃Ta_{6.5}V₅Zr₅Hf₅Mg₅ | 2.0 | | Sputtering | 0.50 | 0.6% |
| 19 | | | | | | |
| Ex. | Pt₄₀Ru₂₇Si₃Sn₃Ta₅V₅W₇Hf₅Mg₅ | 1.2 | | Sputtering | 0.50 | 0.5% |
| 20 | | | | | | |
| Ex. | Pt₅₀W₁₃Ta₇V₅Zr₅Hf₅Mg₁₅ | 1.0 | | Sputtering | 0.43 | 0.6% |
| 21 | | | | | | |
| Comp. | Pt₅₀ Ru₅₀ | — | — | Sputtering | 0.42 | 1.5% |
| Ex. 1 | | | | | | |
| Comp. | Pt₄₅Ru₄₅Mg₁₀ | — | — | Sputtering | 0.44 | 1.5% |
| Ex. 2 | | | | | | |
| Comp. | Pt₄₅ Ru₄₅W₁₀ | — | — | Sputtering | 0.44 | 2% |
| Ex. 3 | | | | | | |
| Comp. | Pt₄₀Ru₄₀W₁₀Sn₁₀ | 1.3 | 0.3 | Sputtering | 0.46 | 1.0% |
| Ex. 4 | | | | | | |
| Comp. | Pt₄₀Ru₄₀W₁₀Mg₁₀ | 100 | | Solution | 0.37 | 0.5% |
| Ex. 5 | | | | method | | |
| Comp. | Pt_{24.1}Ru_{0.5}Mg_{75.4} | — | — | Sputtering | 0.40 | 0.5% |
| Ex. 6 | | | | | | |
| Comp. | Pt_{1.1}Ru_{12.6}Mg_{86.3} | — | — | Sputtering | 0.39 | 3% |
| Ex. 7 | | | | | | |
| Comp. | Pt_{3.7}Ru_{0.9}Ni_{1.9}Zr_{74.8}Mg_{18.7} | — | — | Atomization | 0.42 | 0.5% |
| Ex. 8 | | | | | | |
| Comp. | Pt₁₀Ru₁₀Mg₈₀ | — | | Coating | 0.43 | 3% |
| Ex. 9 | | | | | | |
| Comp. | Pt₃₃Ru₂₃Ni₃₁Zr₁₃ | | 0.5 | Sputtering | 0.47 | 1.6% |
| Ex. | | | | | | |
| 10 | | | | | | |
| Comp. | Pt₃₅Ru₂₅W₁₀Mg₃₀ | 0.7 | | Sputtering | 0.46 | 0.5% |
| Ex. | | | | | | |
| 11 | | | | | | |
| Comp. | Pt₃₀Ru₂₀W₄₅Mg₅ | 1.6 | | Sputtering | 0.46 | 0.6% |
| Ex. | | | | | | |
| 12 | | | | | | |

<XPS Measurement>

XPS measurement was carried out for the above various catalysts with Quantum-2000 manufactured by ULVAC-PHI, INC. A neutralization gun (an electron gun, an argon gun) was used for charge-up compensation and electrification correction (C1s:C—C=284.6 eV).

### <Catalysts of Examples of Present Invention and Comparative Examples>

In the present specification, when the number of types of element T contained in catalyst particles is two or more, element T having the highest content is referred to as “main element T.” For example, the main element T in the catalyst particles of Example 5 is hafnium, and the main element T in the catalyst particles of Comparative Example 4 is tungsten and tin. When the main elements T in the catalysts of Examples 1 to 10, 12, 13, and 18 to 20, and Comparative Examples 3, 4, and 7 to 9 in Table 1 are silicon (Si), tungsten (W), molybdenum (Mo), vanadium (V), tantalum (Ta), and chromium (Cr) (hereinafter referred to as “T1”), it was found that the area of the oxygen bond-derived peak of the element T1 in an XPS spectrum is four times or less the metal bond-derived peak area of the same element. Further, when the main elements T are titanium (Ti), hafnium (Hf), tin (Sn), zirconium (Zr), and niobium (Nb) (hereinafter referred to as “T2”), it was found that the area of the metal bond-derived peak of the element T2 in an XPS spectrum is twice or less the oxygen bond-derived peak area of the same element.

Specifically, as shown in Table 2, for vanadium element, the metal bond component and the oxidative bond component were separated from peaks of a binding energy in the range of 512 to 513 eV and a binding energy in the range of 516 to 517 eV in a V 2p spectrum. For hafnium element, the metal bond component and the oxidative bond component were separated from peaks of a binding energy in the range of 14 to 15 eV and a binding energy in the range of 17 to 19 eV in a Hf 4f spectrum. For niobium element, the metal bond component and the oxidative bond component were separated from peaks of a binding energy in the range of 202 to 203 eV and a binding energy in the range of 203 to 209 eV in an Nb 3d spectrum. For tungsten element, the metal bond component and the oxidative bond component were separated from peaks of a binding energy in the range of 31 to 34 eV and a binding energy in the range of 36 to 40 eV in a W 4f spectrum. For elements having two overlapped peaks, the metal bond part and the oxidative bond part were separated from each other by waveform separation.

TABLE 2

| | Metal bond-derived | Oxygen bond-derived |
|---|---|---|
| Element | peak, eV | peak, eV |
| V | 512-513 (2p3/2) | 516-517 (2p3/2) |
| W | 31-34 (4f7/2) | 36-40 (4f5/2) |
| Mo | 227-228 (3d252) | 235-237 (3d2/5) |
| Nb | 202-203 (3d5/2) | NbO: 203-205 |
| | | (3d3/2) |
| | | Nb₂O₅: 209-211 |
| | | (3d5/2) |
| Cr | 574 (2p3/2) | 576-580 (2p3/2) |
| Zr | 178-179 (3d5/2) | ZrO₂: 184-185 |
| | | (3d3/2) |
| Ti | 453-454 (2p3/2) | TiO: 455-456 |
| | | (2p3/2) |
| | | TiO₂: 459-460 |
| | | (2p3/2) |
| Ta | 23-24 (4f7/2) | 27-29 (4f5/2) |
| Si | 99-100 (2p) | 103-104 (2p) |
| Al | 117-118 (2s) | 120-121 (2s) |
| Sn | 493-494 (3d3/2) | 494-496 (3d3/2) |
| Hf | 14-15 (4f7/2) | 17-19 (4f5/2) |

The numerical values described in the column of T1 (for Si, W, Mo, V, Ta, or Cr) in Table 1 are the proportion of the area of the oxygen bond-derived peak by presuming the area of the metal bond-derived peak to be 1. On the other hand, the numerical values described in the column of T2 (for Ti, Hf, Sn, Zr, or Nb) in Table 1 are the proportion of the area of the metal bond-derived peak by presuming the area of the oxygen bond-derived peak to be 1.

The supported catalysts of Examples 1 to 20 were analyzed by XRD (X-ray diffractometry). As a result, it was found that the spacing between crystal faces in a main peak in the diffraction pattern was in the range of 2.16 to 2.25 angstroms. The average particle diameter of catalyst particles in each catalyst was determined by observation under TEM (transmission electron microscope) for five arbitrary different visual fields. In this case, for each visual field, the diameters of 20 particles were measured, and the diameters of 100 particles in total were averaged. As a result, the particle diameter of each catalyst particle was in the range of 3 to 5 nm.

The catalysts of Examples 1 to 20 and Comparative Examples 1 to 9 were used as an anode catalyst. A standard cathode electrode (carbon black supported platinum catalyst, commercially available product, manufactured by Tanaka Kikinzoku Kogyo K.K.) was used as a cathode in combination with the anode catalyst. A fuel cell electrode, a membrane electrode assembly, and a unit cell were produced by the following methods and were then evaluated.

<Production of Anode Electrode>

At the outset, 3 g of various catalysts produced above was weighed. These catalysts, together with 8 g of pure water, 15 g of a 20% Nafion solution, and 30 g of 2-ethoxyethanol, were thoroughly stirred for dispersion to prepare a slurry. The slurry was coated by a control coater onto a carbon paper subjected to water repellent treatment (350 μm, manufactured by Toray Industries, Inc.), and the coated carbon paper was dried to produce an anode electrode of which the noble metal catalyst loading density was 1 mg/cm².

<Production of Cathode Electrode>

At the outset, 2 g of a platinum catalyst (manufactured by Tanaka Kikinzoku Kogyo K.K.) was weighed. The platinum catalyst, together with 5 g of pure water, 5 g of a 20% Nafion solution, and 20 g of 2-ethoxyethanol, were thoroughly stirred for dispersion to prepare a slurry. The slurry was coated by a control coater onto a carbon paper subjected to water repellent treatment (350 μm, manufactured by Toray Industries, Inc.), and the coated carbon paper was dried to produce a cathode electrode of which the noble metal catalyst loading density was 2 mg/cm².

<Production of Membrane Electrode Assembly>

The cathode electrode and the anode electrode were cut into a size of 3.2×3.2 cm square so that the electrode area of each of the cathode electrode and the anode electrode was 10 cm². Nafion 117 (Du Pont Japan Ltd.) was held as a proton conductive solid polymer film between the cathode electrode and the anode electrode, followed by thermocompression bonding under conditions of temperature 125° C., time 10 min, and pressure 30 kg/cm² to produce a membrane electrode assembly.

A unit cell in a fuel direct supply-type polymer electrolyte fuel cell was produced using the membrane electrode assembly and a flow passage plate. Discharge was carried out at a current density of 150 mA/cm² in such a state that a 1 M aqueous methanol solution as a fuel was supplied into the unit cell in its anode electrode at a flow rate of 0.6 mL/min, air was supplied into the cathode electrode at a flow rate of 200 mL/min, and the cell was maintained at 60° C. Thirty min after the start of discharge, the cell voltage was measured. The results are also shown in Table 1.

As is apparent from the results shown in Table 1, comparison of Examples 1 to 20 and Comparative Examples 2 and 3 with Comparative Example 1 shows that, for Examples 1 to 20 and Comparative Examples 2 and 3, by virtue of the effect of additive element, the activity was higher than that for PtRu of Comparative Example 1 where no element was added. Further, comparison of Example 1 with Comparative Examples 3 and 4 shows that the addition of magnesium (Mg) significantly contributes to an improvement in activity. Comparison of Examples 1 to 3 with Comparative Example 8 shows that, when the content of magnesium was above the upper limit of a magnesium content range of 0.5 to 20 atm %, the activity was lowered. Comparison of Examples 1 to 5 with Comparative Example 9 shows that, when the content of the element T was more than 40 atm %, the activity was lowered. Comparison of Example 1 with Comparative Example 5 shows that sputtering could provide higher activity than the solution method, suggesting that difference in catalyst synthesis process develops a difference in catalytic activity.

For Comparative Example 6 (Example 1 of U.S. Pat. No. 5,872,074) where the content of magnesium was high and 80 atom %, the activity was low. Further, comparison of Examples 1 to 3 with Comparative Example 7 shows that Examples 1 to 3 where the magnesium content was 0.5 to 20 atm % had provided higher activity than Comparative Example 7, indicating that the addition of magnesium contributed to an improvement in activity.

Finally, the long-term stability of the catalyst was determined by measuring the voltage 1000 hr after the start of power generation for each MEA and calculating the following defined percentage deterioration. The results are shown in Table 1.

Deterioration (%)=(Initial voltage−Voltage after 1000 hr)×100/initial voltage

As a result, it was found that the percentage deterioration was 1.5% for PtRu and 1.5 to 3% for three-way catalysts, whereas, for four or higher way MEAs where magnesium was added, the percentage deterioration was in the range of 0.5% to 0.6%, indicating that the percentage deterioration was significantly improved. From the above results, it is apparent that the addition of magnesium is effective from the viewpoint of the effect of improving the activity, as well as from the viewpoint of improving the stability.

The same effect could be confirmed for polymer electrolyte fuel cells using the catalysts of the Examples of the present invention. Accordingly, the catalysts of the Examples of the present invention were also more effective for CO poisoning than the conventional PtRu catalyst.

As described above, the present invention can provide highly active and stable catalyst and fuel cell.

The present invention is not limited to the above embodiments. In practicing the invention, structural elements may be modified and embodied without departing from the spirit of the invention. A plurality of structural elements disclosed in the embodiments may be properly combined to constitute various inventions. For example, some of structural elements may be omitted from all the structural elements in the embodiments. Further, structural elements in different embodiments may be properly combined.

1. A catalyst comprising:
an electro conductive support; and
catalyst particles supported on the electro conductive support and having a composition represented by formula (1)
PtᵤRuₓMg_{y}T_{z} (1)
wherein u is 30 to 60 atm %, x is 20 to 50 atm %, y is 0.5 to 20 atm %, and z is 0.5 to 40 atm %,
element T being selected from the group consisting of silicon (Si), tungsten (W), molybdenum (Mo), vanadium (V), tantalum (Ta), chromium (Cr), titanium (Ti), hafnium (Hf), tin (Sn), zirconium (Zr), niobium (Nb), and combinations thereof, provided that
when element T is selected from the group consisting of silicon, tungsten, molybdenum, vanadium, tantalum, chromium, and combinations thereof, the content of element T having an oxygen bond as determined by a spectrum measured by X-ray photoelectron spectroscopy is four times or less the content of element T having a metallic bond, and
when element T is selected from the group consisting of titanium, hafnium, tin, zirconium, niobium, and combinations thereof, the content of element T having a metallic bond as determined by a spectrum measured by X-ray photoelectron spectroscopy is twice or less the content of element T having an oxygen bond.

2. The catalyst according to claim 1, wherein y is 1 to 10 atm %.

3. The catalyst according to claim 1, wherein, when element T is selected from the group consisting of silicon, tungsten, molybdenum, vanadium, tantalum, chromium, and combinations thereof, the content of element T having an oxygen bond as determined by a spectrum measured by X-ray photoelectron spectroscopy is twice or less the content of element T having a metallic bond.

4. The catalyst according to claim 1, wherein, when element T is selected from the group consisting of titanium, hafnium, tin, zirconium, niobium, and combinations thereof, the content of element T having a metallic bond as determined by a spectrum measured by X-ray photoelectron spectroscopy is one time or less the content of element T having an oxygen bond.

5. The catalyst according to claim 1, wherein the spacing between crystal faces is 2.16 to 2.25 angstroms.

6. The catalyst according to claim 1, wherein the catalyst further comprises oxygen.

7. The catalyst according to claim 6, wherein the content of oxygen is not more than 25 atm %.

8. The catalyst according to claim 1, wherein the average particle diameter of the catalyst particles is not more than 10 nm.

9. The catalyst according to claim 1, wherein the electro conductive support is carbon black.

10. The catalyst according to claim 1, wherein the electro conductive support is an electro conductive carbon fiber-containing porous paper, electrode diffusion layer, or electrolyte membrane.

11. A process for producing a catalyst according to claim 1, comprising the step of depositing platinum, ruthenium, magnesium, and element T on an electro conductive support held at 400° C. or below by sputtering or vapor deposition.

12. The process according to claim 11, wherein, in the sputtering, an alloy target is used, or two or more types of metallic elements are simultaneously sputtered.

13. The process according to claim 11, wherein, after the formation of catalyst particles by sputtering or vapor deposition, pickling treatment or heat treatment is carried out.

14. The process according to claim 13, wherein the heat treatment is carried out at 10 to 400° C. or below in an atmosphere having an oxygen partial pressure of less than 5%.

15. A membrane electrode assembly comprising a cathode, an anode comprising a catalyst according to claim 1, and a proton-conductive film provided between the cathode and the anode.

16. A fuel cell comprising a membrane electrode assembly according to claim 15.
